(19) United States
(12) Patent Application Publication
(10) Pub. No.: US 2025/0303527 A1
(43) Pub. Date: Oct. 2, 2025

(54) VEHICLE HANDLE EXTENSION WITH END EFFECTOR

(71) Applicant: Ford Global Technologies, LLC, Dearborn, MI (US)

(72) Inventors: Dawn Piechocki, Gross Pointe Park, MI (US); Taylor Remington, Canton, MI (US); Thomas Lincoln, Dearborn, MI (US); Nadir Malik, Plymouth, MI (US)

(21) Appl. No.: 18/623,137

(22) Filed: Apr. 1, 2024

(51) Int. Cl. B25B 9/00; B25G 1/04; B62D 33/027

(52) U.S. Cl. CPC B25B 9/00; B25G 1/04; B62D 33/0273

(57) ABSTRACT

An assembly comprises a vehicle structure, a handle that is selectively removable from the vehicle structure, and an end effector at one end of the handle. The handle is selectively moveable along an axis between an extended position and a retracted position. The end effector has a contact surface that is non-parallel with the axis.

### TECHNICAL FIELD

This disclosure relates generally to an extendible handle that is selectively detachable from a moveable vehicle panel to facilitate removing items from a cargo area.

### BACKGROUND

Vehicles include cargo areas that are used to transport various types of items. Accessing these items for removal from the cargo area may be challenging.

### SUMMARY

An assembly according to an exemplary aspect of the present disclosure includes, among other things: a vehicle structure; a handle that is selectively removable from the vehicle structure, wherein the handle is selectively moveable along an axis between an extended position and a retracted position; and an end effector at one end of the handle that has a contact surface that is non-parallel with the axis.

In a further non-limiting embodiment of the foregoing assembly, the end effector comprises a grasping element.

In a further non-limiting embodiment of any of the foregoing assemblies, the end effector is moveable relative to the handle between a stowed position and a deployed position.

In a further non-limiting embodiment of any of the foregoing assemblies, a first lock feature holds the end effector in the stowed position and a second lock feature holds the end effector in the deployed position.

In a further non-limiting embodiment of any of the foregoing assemblies, the handle is comprised of a plurality of telescoping members.

In a further non-limiting embodiment of any of the foregoing assemblies, the handle is comprised of a plurality of nested tubes.

In a further non-limiting embodiment of any of the foregoing assemblies, the handle includes a release member to move the handle to the extended position.

In a further non-limiting embodiment of any of the foregoing assemblies, the vehicle structure comprises a tailgate.

An assembly according to an exemplary aspect of the present disclosure includes, among other things: a tailgate; a handle that is selectively removable from the tailgate, wherein the handle is selectively moveable along an axis between an extended position and a retracted position; and an end effector at one end of the handle that is selectively moveable between a stowed position and a deployed position.

In a further non-limiting embodiment of any of the foregoing assemblies, the end effector comprises a hook or grasping element that has a contact surface that is non-parallel with the axis.

In a further non-limiting embodiment of any of the foregoing assemblies, a first lock feature holds the end effector in the stowed position and a second lock feature holds the end effector in the deployed position.

In a further non-limiting embodiment of any of the foregoing assemblies, the handle is comprised of a plurality of telescoping members, and wherein one telescoping member of the plurality of telescoping members has a smaller cross-section and another telescoping member of the plurality of telescoping members.

In a further non-limiting embodiment of any of the foregoing assemblies, the handle is comprised of a plurality of nested tubes, and wherein a distal tube of the plurality of nested tubes slides inwardly within an adjacent tube of the plurality of nested tubes when moving to the retracted position.

In a further non-limiting embodiment of any of the foregoing assemblies, the handle includes a release member to move the handle to the extended position.

In a further non-limiting embodiment of any of the foregoing assemblies, the tailgate is movable relative to a plurality of truck bed side walls between an open position and a closed position, and wherein the handle is moveable from a stowed position within the tailgate to an upright position when the tailgate is in the open position.

In a further non-limiting embodiment of any of the foregoing assemblies, the end effector comprises a hook or grasping element at a distal end of the handle that is configured to interact with items located within a cargo area defined by the plurality of truck bed side walls.

A method according to an exemplary aspect of the present disclosure includes, among other things: selectively removing a handle from one of a plurality of side walls that surround a cargo area; selectively moving the handle along an axis between an extended position and a retracted position; and selectively deploying an end effector at one end of the handle to interact with items located within the cargo area, wherein the end effector has a contact surface that is non-parallel with the axis.

In a further non-limiting embodiment of the foregoing method, the method includes locking the end effector in a stowed position before returning the handle to the retracted position.

In a further non-limiting embodiment of any of the foregoing methods, the method includes locking the end effector in a deployed position.

In a further non-limiting embodiment of any of the foregoing methods, the end effector is locked in the stowed position with a first lock feature and is locked in the deployed position with a second lock feature that is different that the first lock feature.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a cargo area.

FIG. 2A is a schematic side view of a tailgate with an extendable handle in a first position.

FIG. 2B is similar to FIG. 2A but shows the extendable handle in a second position.

FIG. 2C shows a portion of the extendable handle being removed from the vehicle.

FIG. 3A shows one side view of an example of a selectively removeable handle in an extended position.

FIG. 3B shows another side view of the selectively removeable handle of FIG. 3A.

FIG. 4A is a perspective view of one example of an end effector of a selectively removeable handle.

FIG. 4B is a perspective view of another example of an end effector of a selectively removeable handle.

FIG. 4C is a perspective view of another example of an end effector of a selectively removeable handle.

FIG. 5 is a side view of a release button configuration for the handle of FIGS. 3A-3B.

FIG. 6A shows one side view of another example of a selectively removeable handle in an extended position.

FIG. 6B shows another side view of the selectively removeable handle of FIG. 6A.

FIG. 7 shows one side view of another example of a selectively removeable handle in an extended position.

FIG. 8A is a perspective view of an end effector in the deployed position.

FIG. 8B shows the end effector of FIG. 8A in the stowed position.

FIG. 8C is a perspective view of the end effector of FIG. 8A with a lock member.

FIG. 9A is a perspective view of the lock member of FIG. 8C.

FIG. 9B is an end view of the lock member of FIG. 9A.

FIG. 10 is a magnified perspective view of a first lock feature.

FIG. 11A is a magnified perspective view of a second lock feature.

FIG. 11B is a perspective view of the end effector in the stowed position and interacting with the second lock feature.

### DETAILED DESCRIPTION

This disclosure details a system and method where an extendible handle is selectively detachable from a moveable vehicle panel to facilitate removing items from a cargo area. The handle includes an end effector that is selectively deployed to interact with the items.

FIG. 1 illustrates a vehicle 10 that includes a passenger compartment 12 and a cargo bed area 14 that is aft the passenger compartment 12. In this example, the vehicle 10 is a pickup truck. The vehicle 10 could be another type of vehicle in another example, such as a car, van, sport utility vehicle, etc. In this example, the cargo bed area 14 is defined by a rear wall 16, a moveable wall/panel, e.g., a tailgate 18, and a pair of opposing side walls 20 that extend between the rear wall 16 and the tailgate 18. The cargo bed area 14 further includes a bottom surface 22 that can support various items 24. In this example, the tailgate 18 is selectively moveable relative to the truck bed side walls 20 between an open position (FIG. 1) and a closed position.

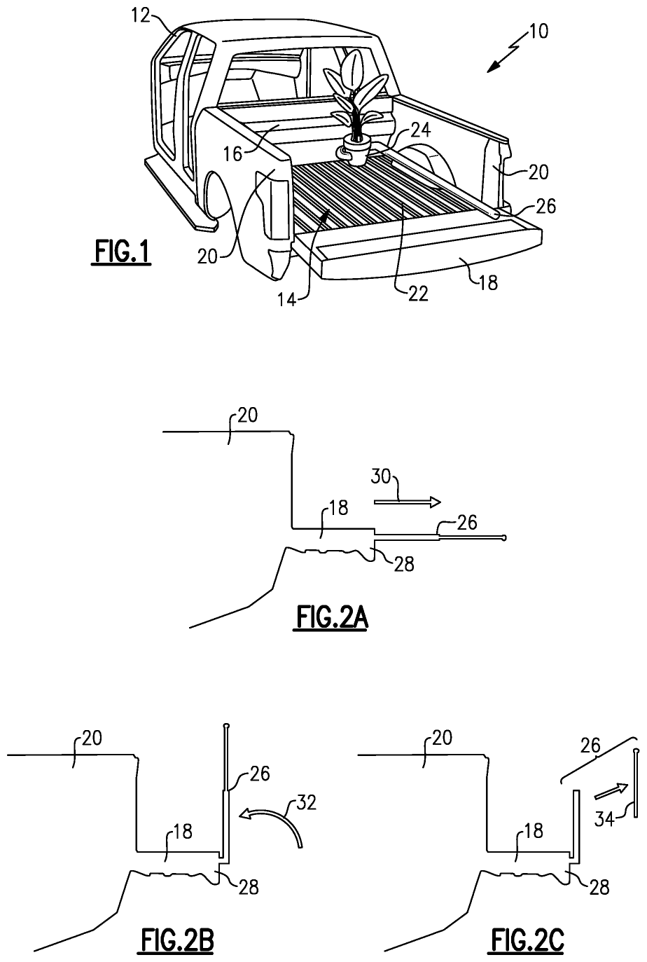

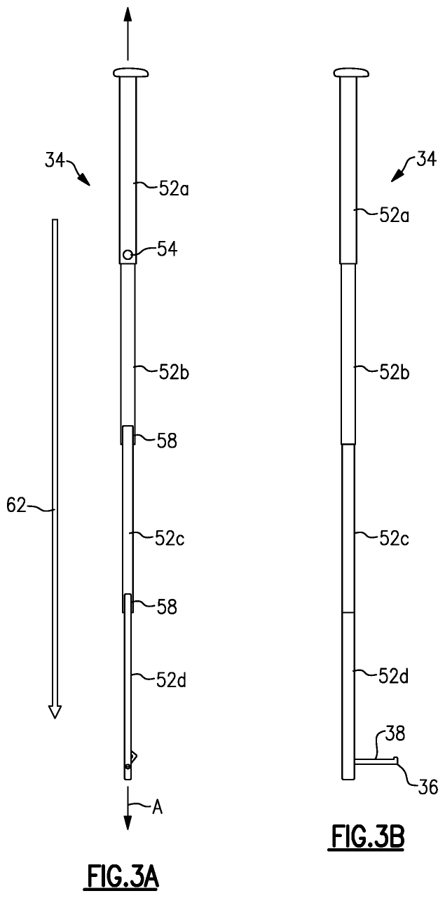

When the tailgate 18 is in the open position as shown in FIG. 2A, a handle 26 is selectively extended from a distal end 28 of the tailgate as indicated by arrow 30. The handle 26 can then be pivoted to an upright position, as indicated by arrow 32 in FIG. 2B, and locked into place. This handle 26 can then function as a grasping member to facilitate a user in climbing up into the cargo bed area 14, for example. In one example, the disclosure provides for at least a portion 34 of the handle 26 to be selectively removable from a vehicle structure, such as the tailgate 18, for example, as shown in FIG. 2C. In one example, a release member such as a button is used to remove the handle portion 34; however, other release mechanisms could also be used. The portion of the handle 26 could also be removeable from other vehicle structures such as side walls, door panels, etc.

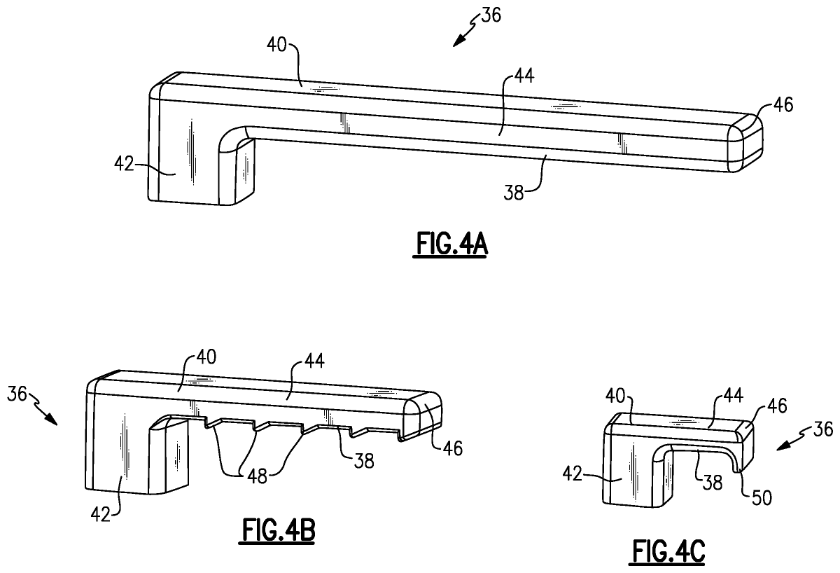

In one example, the removable portion of the handle 26 comprises an extendable handle 34 that is selectively moveable along an axis A between an extended position (FIG. 3A) and a retracted position (FIG. 2C). An end effector 36 is located at one end of the handle 34. The end effector 36 is moveable relative to the handle 34 between a stowed position (FIG. 3A) and a deployed position (FIG. 3B). As shown in FIG. 3B, the end effector 36 has a contact surface 38 that is non-parallel with the axis A.

In one example, the end effector 36 comprises pivoting arm forming a grasping or hook element that can be used to interact with items 24 in the cargo bed area 14. For example, when the handle 24 is in the extended position and the end effector 36 is in the deployed position, the grasping or hook element can be used to reach items, e.g., boxes, sports equipment, bags, crates, tools, etc., in the cargo area 14 without having to climb into the cargo area itself. In one example, the end effector 36 comprises a body 40 having one portion 42 that is coupled to the handle 34 at a connection interface that allows the selective movement between the deployed and stowed positions. The body 40 has a second portion 44 that extends outwardly to a distal end 46. The body includes at least one contact surface 38 that is configured to interact with items 24 (FIG. 1). In one example, the body 40 comprises an L-shape; however, other shapes could also be used.

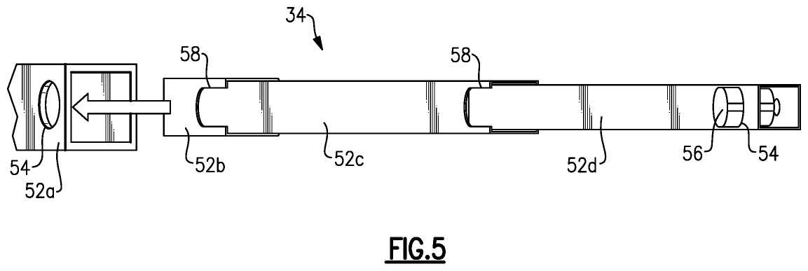

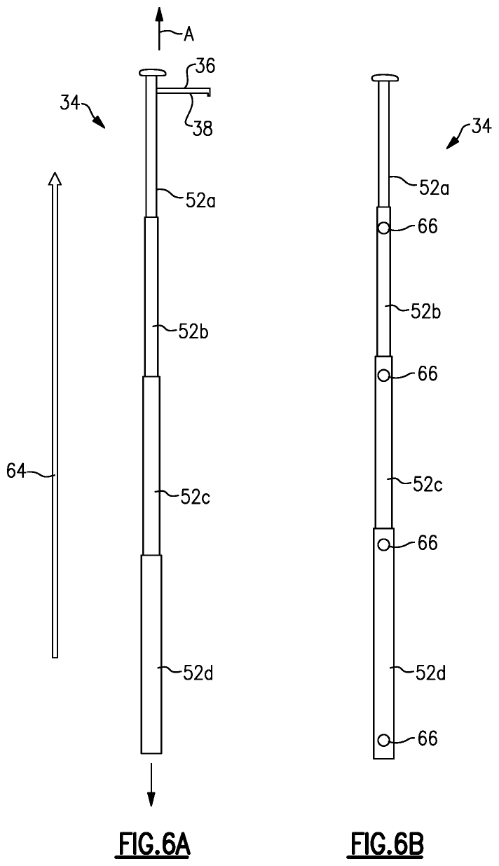

In one example, the second portion 44 of the end effector 36 is a straight linear element with a smooth contact surface 38 as shown in FIG. 4A. The length of the second portion 44 can be varied as needed to accommodate any design constraints or packaging issues.

In another example, the second portion 44 of the end effector 36 is a straight linear element with a contact surface 38 having a plurality of ribs or protrusions 48 as shown in FIG. 4B. Again, the length of the second portion 44 can be varied as needed.

In another example, the second portion 44 of the end effector 36 is a straight linear element that extends to the distal end 46 and includes a lip, hook, or extension portion 50 that is non-parallel with the second portion 44. In this example, the contact surface 38 can either be smooth as shown in FIG. 4A or can include ribs or protrusions 48 as shown in FIG. 4B. Again, the length of the second portion 44 can be varied as needed.

In one example, the handle 34 is comprised of a plurality of telescoping members 52a, 52b, 52c, 52d as shown in FIGS. 3A-3B. In one example, the top 52a and bottom 52d members have a hole 54 (see FIG. 5) that is associated with a release button 56 that is selectively actuated to move the handle 34 to the extended position. In this example, the interior members 52b, 52c have slots 58 to slide over the release button 56 without having to activate the button. In one example, the release button 56 and the end effector 36 are located on the smallest tube, e.g. the bottom member 52d.

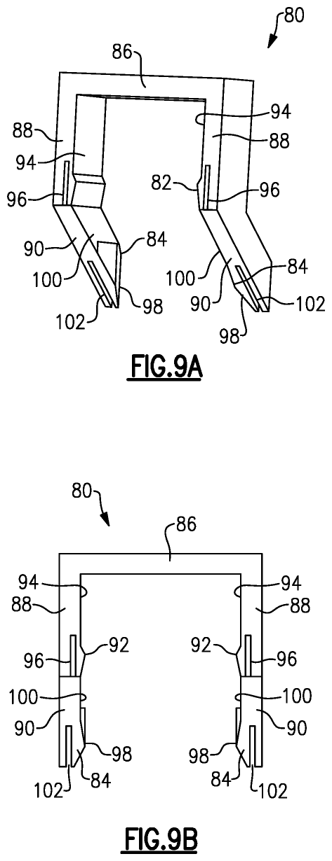

In one example, the telescoping members 52a, 52b, 52c, 52d are narrower at the bottom than at the top of the handle 34, as shown in FIGS. 3A-3B, and stay in the extended position via friction. In one example, the bottom member 52d has a smaller cross-sectional area than a cross-sectional area of the top member 52a. The cross-section can be polygonal, e.g., square, or curved, e.g., round, oval, etc., with a channel 60 (FIG. 8A) through one side of the bottom member 52d such that the end effector 36 can only be deployed in one direction and will not rotate in the user's hand. In this example, the bottom member 52d extends away from the top of the handle 34 in a direction as indicated by arrow 62 as shown in FIG. 3A.

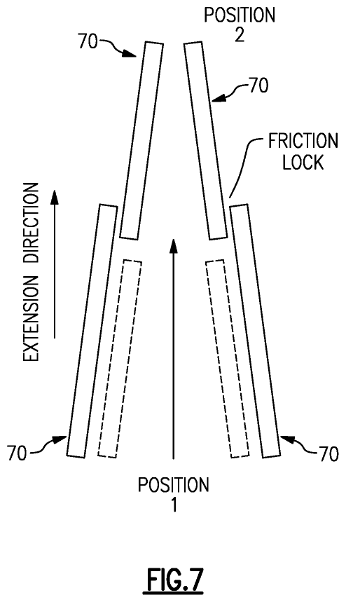

In another example shown in FIGS. 6A-6B, the top member 52a of the handle 34 extends upwardly relative to the bottom member 52d in a direction as indicated by arrow 64 in FIG. 6A. In this example, the top member 52a has the smallest cross-section. Also in this example, every member has a locking button 66 to lock in the handle 34 in a desired length for the extended position. The end effector 36 is selectively moveable between a deployed position (FIG. 3A) and an extended position (FIG. 3B) and is located in the top member 52a, which has the smallest cross-section.

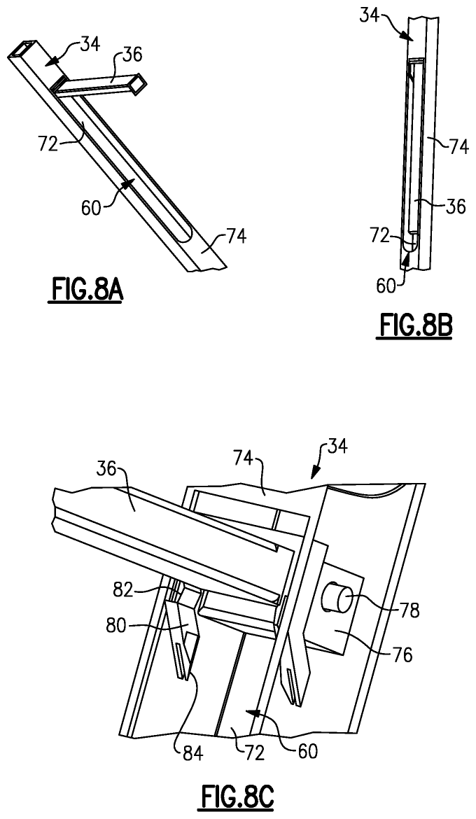

In another example shown in FIG. 7, the handle 34 is comprised of a plurality of nested tubes 70 that are moveable between an extended position and a retracted position. When inner pieces are extended upwards from Position 1 to Position 2 as shown in FIG. 7, the interface tightens between the two pieces creating a locked position through friction. The tubes 70 may have a square cross-section or comprise a round tube with an anti-rotation feature. The tubes 70 are nested and angled so the tubes 70 stay extended via friction. When moving to the retracted position, the upper tube would slide within the lower tube. In this example, one of the tubes 70 would include an end effector that is configured similar to that which is described above.

In one example, a method of operation includes selectively removing the handle 34 from one of a plurality of side walls that surround a cargo area 14, and then selectively moving the handle 34 along an axis A between an extended position and a retracted position. The method further includes selectively deploying an end effector 36 at one end of the handle 34 to interact with items 24 located within the cargo area 14.

As discussed above, the portion of the handle 34 associated with the end effector 36 includes a channel 60 in a handle portion 74 such that the end effector 36 can only be deployed in one direction as shown in FIG. 8A. As such, there is a wall 72 in the handle portion 74 opposite of the channel 60 to prevent the end effector 36 from moving in an opposite direction. The end effector 36 folds into the channel 60 (FIG. 8B) so that the receiving member can fit within the adjacent member.

As shown in FIG. 8C, in one example, the end effector 36 includes a connection portion 76 that is pivotally connected to the handle portion 74 via a pin 78 that is fixed to the handle portion 74. Other types of rotational connections could also be used.

In one example, the method includes locking the end effector 36 in a stowed position before returning the handle 34 to the retracted position.

In one example, the method includes locking the end effector 36 in the deployed position.

In one example, the end effector 36 is locked in the deployed position with a first lock feature and is locked in the stowed position with a second lock feature that is different that the first lock feature.

In one example, an end effector lock 80 cooperates with the connection portion 76 of the end effector 36 to provide the first and second lock features. The end effector lock 80 is received within the channel 60 of the handle portion 74 as shown in FIG. 8C.

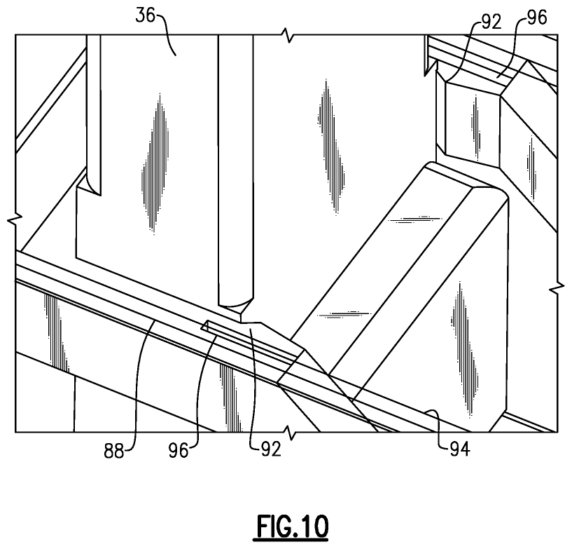

FIGS. 9A-9B show the end effector lock 80 in greater detail. In one example, a first lock feature 82 of the end effector lock 80 locks the end effector 36 in the deployed position, and a second lock feature 84 of the end effector lock 80 locks the end effector 36 in the stowed position. In one example, the end effector lock 80 has a central body portion 86 with one first leg portion 88 extending away from each end of the central body portion 86, and with one second leg portion 90 extending away from each first leg portion 88. The second leg portions 90 are non-parallel with the first leg portions 88 and the central body portion 86. In one example, the first leg portions 88 are perpendicular relative to the central body portion 86 and the second leg portions 90 are non-perpendicular relative to the first leg portions 88. The central body portion 86 also serves as an end stop for a range of motion of the end effector 36.

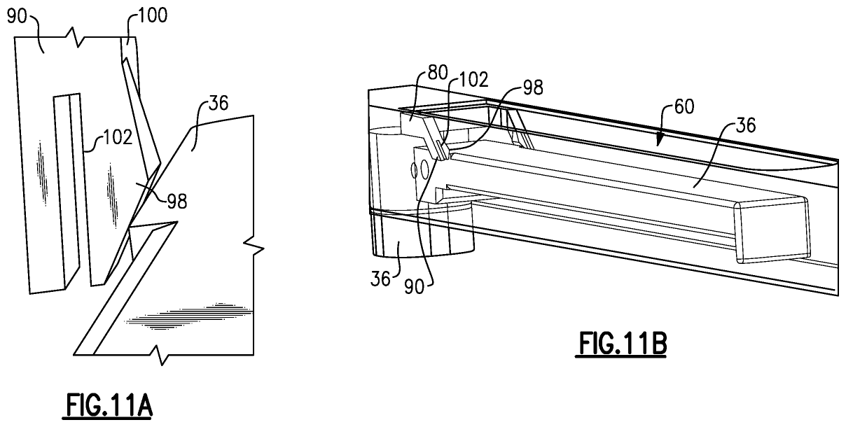

In one example, the first leg portions 88 include the first lock feature 82. In one example, the first lock feature 82 comprises a ramped protrusion 92 that extends outwardly of an inner surface 94 of each first leg portion 88. When in the deployed position (FIG. 8C) the ramped protrusions 92 hold the body of the end effector 36 in the locked deployed position as shown in FIG. 10. In this example, each of the first leg portions 88 includes at least one slot 96 that creates a resilient mechanism to allow the end of the end effector 36 to compress the protrusions 92 inwardly, due to a user grasping the end effector 36 to move to the deployed position, and then subsequently spring back to hold the end effector in the deployed position once the user releases the end effector 36. The resilient mechanism also facilitates returning the end effector 36 to the stowed position during the reverse movement.

In one example, the second leg portions include the second lock feature 84. In one example, the second lock feature 84 comprises a ramped protrusion 98 that extends outwardly of an inner surface 100 of each second leg portion 90. When in the closed position (FIGS. 11A-11B) the ramped protrusions 98 hold the body of the end effector 36 in the locked stowed position as shown in FIG. 11B. This comprises a friction fit that is in addition to a physical barrier. In this example, each of the second leg portions 90 includes at least one slot 102 that creates a resilient mechanism to allow the end of the end effector 36 to compress the protrusions 98 inwardly, due to a user grasping the end effector 36 to move to the stowed position, and then subsequently spring back to hold the end effector in the stowed position once the user releases the end effector 36. The resilient mechanism also facilitates returning the end effector 36 to the deployed position during the reverse movement.

The subject disclosure provides a selectively removeable handle/tool that offers the advantage of allowing the customer to access a cargo area without climbing into it. The handle is removeable from an existing vehicle structure and has an end effector, e.g., a rotating arm, to aid in collecting items. The handle also does not take up any space and is secured during vehicle operation such that it is not moving around the cargo area or generating noise while not in use.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly comprising:
a vehicle structure;
a handle that is selectively removable from the vehicle structure, wherein the handle is selectively moveable along an axis between an extended position and a retracted position; and
an end effector at one end of the handle that has a contact surface that is non-parallel with the axis.

2. The assembly of claim 1, wherein the end effector comprises a grasping element.

3. The assembly of claim 1, wherein the end effector is moveable relative to the handle between a stowed position and a deployed position.

4. The assembly of claim 3, including a first lock feature that holds the end effector in the stowed position and a second lock feature that holds the end effector in the deployed position.

5. The assembly of claim 1, wherein the handle is comprised of a plurality of telescoping members.

6. The assembly of claim 1, wherein the handle is comprised of a plurality of nested tubes.

7. The assembly of claim 1, wherein the handle includes a release member to move the handle to the extended position.

8. The assembly of claim 1, wherein the vehicle structure comprises a tailgate.

9. An assembly comprising:
a tailgate;
a handle that is selectively removable from the tailgate, wherein the handle is selectively moveable along an axis between an extended position and a retracted position; and
an end effector at one end of the handle that is selectively moveable between a stowed position and a deployed position.

10. The assembly of claim 9, wherein the end effector comprises a hook or grasping element that has a contact surface that is non-parallel with the axis.

11. The assembly of claim 10, including a first lock feature that holds the end effector in the stowed position and a second lock feature that holds the end effector in the deployed position.

12. The assembly of claim 9, wherein the handle is comprised of a plurality of telescoping members, and wherein one telescoping member of the plurality of telescoping members has a smaller cross-section and another telescoping member of the plurality of telescoping members.

13. The assembly of claim 9, wherein the handle is comprised of a plurality of nested tubes, and wherein a distal tube of the plurality of nested tubes slides inwardly within an adjacent tube of the plurality of nested tubes when moving to the retracted position.

14. The assembly of claim 9, wherein the handle includes a release member to move the handle to the extended position.

15. The assembly of claim 9, wherein the tailgate is movable relative to a plurality of truck bed side walls between an open position and a closed position, and wherein the handle is moveable from a stowed position within the tailgate to an upright position when the tailgate is in the open position.

16. The assembly of claim 15, wherein the end effector comprises a hook or grasping element at a distal end of the handle that is configured to interact with items located within a cargo area defined by the plurality of truck bed side walls.

17. A method comprising:
selectively removing a handle from one of a plurality of side walls that surround a cargo area;
selectively moving the handle along an axis between an extended position and a retracted position; and
selectively deploying an end effector at one end of the handle to interact with items located within the cargo area, wherein the end effector has a contact surface that is non-parallel with the axis.

18. The method of claim 17, including locking the end effector in a stowed position before returning the handle to the retracted position.

19. The method of claim 18, including locking the end effector in a deployed position.

20. The method of claim 19, wherein the end effector is locked in the stowed position with a first lock feature and is locked in the deployed position with a second lock feature that is different that the first lock feature.
